(19) United States
(12) Patent Application Publication
(10) Pub. No.: US 2009/0094640 A1
(43) Pub. Date: Apr. 9, 2009

(54) TARGETED ADVERTISING IN UNICAST, MULTICAST AND HYBRID DISTRIBUTION SYSTEM CONTEXTS

(76) Inventors: Bruce J. Anderson, Chesterfield, NJ (US); Patrick M. Sheehan, Jamison, PA (US); Daniel C. Wilson, Edmonton (CA)

Correspondence Address: MARSH, FISCHMANN & BREYFOGLE LLP, 8055 East Tufts Avenue, Suite 450, Denver, CO, 80237, US

(21) Appl. No.: 12/239,475

(22) Filed: Sep. 26, 2008

Related U.S. Application Data
(60) Provisional application No. 60/975,271, filed on Sep. 26, 2007.

(51) Int. Cl. H04N 7/025; H04N 7/173

(52) U.S. Cl. 725/34; 725/35; 725/149; 725/118

(57) ABSTRACT

Systems and methods are presented for the delivery of targeted assets in a scheduled programming network in the context of several content distribution systems, including switched digital, unicast, multicast, and hybrid unicast/multicast content distribution systems. Assets may be targeted to network users in connection with the scheduled network programming, and further, successful delivery of those targeted assets may be confirmed. In this regard, the systems and methods generally select targeted assets from a remote platform and, in some instances, to deliver those targeted assets from the remote platform. The assets may be selected based on demographic or other information obtained from an external source and/or based on monitoring user inputs. In the latter regard, the classification of an audience can be based at least in part on monitoring communications to the remote platform conventionally used for other purposes.

### CROSS-REFERENCE TO RELATED APPLICATION

This application claims priority and the benefit of the filing date under 35 U.S.C. 119 to U.S. Provisional Application No. 60/975,271, entitled, “Targeted Advertising in Unicast, Multicast, and Hybrid Distribution System Contexts,” filed on Sep. 26, 2007 the contents of which are incorporated herein as if set forth in full.

### FIELD OF INVENTION

The present invention is directed to targeting assets (e.g., advertisements) in a content distribution system involving multiple scheduled programming networks. More particularly, the invention relates to a method and apparatus for selecting targeted assets from a remote platform (e.g., based on monitored user inputs or other information) and, in some instances, delivering assets from the remote platform via a switched digital, unicast, multicast, and/or hybrid unicast/multicast content distribution system.

### BACKGROUND OF THE INVENTION

The first regularly scheduled television service in the United States began broadcasting in 1928 with the rest of the world closely following. Over time, two primary paradigms developed for providing scheduled programming: premium networks (e.g., HBO, Showtime, etc.) and advertiser-supported networks (e.g., CNN, ESPN, etc.). While premium networks depend on subscriber fees for their revenue, advertiser-supported networks rely principally on the advertising that they sell. Through advertising revenue, advertiser-supported networks are able to prove substantially “free” television from the viewer's perspective (excepting, of course, a per-subscriber payment from the cable systems carrying the network).

In this regard, advertiser-supported network programming, or content, is commonly mixed with informational content, or assets. These assets commonly include advertisements, but they may also include associated programming, public service announcements, ad tags, weather or emergency notifications, and a variety of other content, including both paid and unpaid content. For example, a television network may broadcast a television program to a wide and diverse audience. Asset providers (e.g., advertisers) desiring to convey information regarding services and/or products (e.g., television commercials) may provide assets to the broadcast network or content providers such that the assets may be aired in connection with the television program. Assets are typically interleaved with the scheduled network programming, or content, during predetermined intervals in the programming (e.g., commercial breaks designated by cues within the programming) but may also be included in or superimposed on the programming.

Asset providers typically pay broadcast network programmers for the opportunity to target assets to an audience. These asset providers generally desire to direct their assets to a selected audience rather than broadcasting their information to all potential audience segments because that would generally be a waste of resources (e.g., certain audience members may not be of interest to the asset provider). To illustrate, an advertiser desiring to deliver a commercial conveying information about men's shaving products may not be particularly interested in delivering the commercial to women or children. Because of this desired directing of assets, audience sampling, such as that performed by Nielsen Media Research Corp. (Nielsen), was established to delineate audiences into sectors. For example, audience sampling may classify audience members into demographical groups based on gender, ethnicity, income level, number of family members, locale, personal interest, etc.

Audience sampling is often performed via the monitoring of selected households. For example, a monitoring company may provide equipment to a number of households. The member households may comprise a fairly diverse audience with profiles in each household that are known to the monitoring company. As such, the monitoring company may monitor the observation patterns of the member households to roughly associate audience profiles with certain content (e.g., television programs). That is, the monitoring company roughly extrapolates the observation patterns of the member households to the audience at large, a process that produces what is generally referred to as “ratings.”

The case of television advertisements is illustrative. Today, advertisers direct their assets based on ratings. For example, an asset provider may wish to display an asset within a certain programming time slot if the rating for that time slot substantially corresponds to the target audience for the asset. For example, an asset provider may wish to show a shaving advertisements during a programming time slot having a relatively high rating among males between the ages of 18 and 32.

Rating-based advertising has been a successful model, and it is still widely employed by advertisers. That said, even in the best case, a significant mismatch between the audience and advertisers' targets still occurs. For example, a programming time slot having a relatively high rating of 70% among males between the ages of 18 and 32 still has a relatively large percentage of 30% of female viewers or other viewers that are not within the advertiser's target audience.

Additionally, the growth in the number of programming channels available to end users of content (e.g., television viewers and radio listeners) has contributed to the difficulty in reaching these users. For example, because audience members are dispersed over many programming channels and audience sampling cannot reach every member of the audience, ratings for certain programs may be insubstantial or immeasurable. In this regard, asset providers may not wish to deliver assets to certain programming channels even though these channels in the aggregate represent large portions of their target audience. Because of these missed opportunities, advertisers miss potential exposure for their goods and services, and Multiple Systems Operators (“MSOs”) such as, for example, cable television operators or other network operators and/or program providers, may lose income. Moreover, viewers may lose exposure to assets of potential interest or, at the least, experience reduced advertiser subsidization of network programming costs. Thus, it would be useful to devise a means to allow asset providers to more accurately target assets to viewers of interest.

As background, there are a variety of content distribution systems that have been proposed and/or implemented for delivering scheduled programming. Examples of these systems include conventional broadcast distribution systems, switched digital broadcast distribution systems, multicast distribution systems, and unicast distribution systems. In a conventional broadcast system, all user equipment devices (“UEDs,” e.g., digital set top boxes, analog set top boxes, digital video recorders, television sets, wireless devices, etc.) in any given content distribution subdivision receive the same content stream or multiplex of content streams. Thus, for example, all UEDs in a given subdivision may receive an identical set of several hundred scheduled programming networks as assigned to specific bandwidth segments or channels. In such conventional broadcast systems, channel selections are fully implemented at the UED; that is, the user inputs a selection (e.g., via a remote control) and a processor at the UED causes the tuner to tune to the corresponding channel.

Switched digital, multicast and unicast systems generally involve communications between the UED and a remote platform in connection with user program/channel selections. In this regard, the UED may communicate with a headend (in the case of cable television) or an intermediate platform of the distribution system. In a switched digital broadcast distribution system, the system is divided into a number of system subdivisions on a relatively fine geographic basis. Each subdivision may receive a different subset of the set of scheduled programming networks available in the content distribution system. For example, the subset of networks broadcast in any given subdivision may depend on the channels requested by viewers within that subdivision. Accordingly, channel selections are communicated to a switch responsible for determining a subset of networks broadcast in that subdivision.

By contrast, in a unicast content distribution system, programming is still scheduled, but an individualized content stream is delivered from a remote delivery platform located separate from the UEDs to each UED. Accordingly, user selections are communicated to a remote platform that is operative to direct such an individualized stream to the UED.

Finally, in a multicast content distribution system, an identical content stream or multiplex of streams is provided to each of multiple UEDs. For example, viewers in a multicast content distribution system may each make a selection from the available scheduled programming networks. Using these selections, viewers may be grouped such that each group of UEDs receives an appropriate, and identical, content stream.

A number of targeted advertising methods and systems have been proposed for use within the content distribution systems discussed above. Generally, these methods and systems use known audience classification parameters, such as, for example, age, gender, ethnicity, income level, locale, personal interests, and/or profession, associated with a given audience (a current user or users, e.g., viewers in the case of television) to select relevant advertisements for UEDs. In this regard, the classification parameters may be determined, for a household or current audience, based on monitoring user inputs and/or by accessing user or household information from a third party database, e.g., associated with a credit processing system. In the case of monitoring user inputs, a variety of user inputs, such as channel selections, volume selections and/or filter selections, to continually estimate the classification parameters associated with a given UED in actual or approximate real-time. In other words, the ability to continually discern the classification parameters associated with the current audience, or understanding “who's watching now” in the case of television may help advertisers target viewers of interest with less error.

In addition, several of the functional steps of targeted advertising, such as determining the audience classification parameters associated with a UED, selecting targeted assets based on the classification parameters as compared to the target parameters associated with each asset, and delivering the targeted assets into the scheduled network programming or content stream to be played at the UED have generally occurred at the UED itself in certain proposed and existing systems. However, there may be cases where it is impracticable or impossible to execute some or all of these functional steps at the UED. For example, some proposed methods for targeted asset delivery require logic resident at each UED to determine classification parameters and compare the parameters with the target asset parameters associated with each asset available in the content distribution system. Based on this comparison, UEDs essentially self-select assets for an upcoming asset spot. This may require substantial processing or storage resources at the UED, which may be undesirable. In addition, a fully UED based system may have limited access to third party database information or require significant bi-directional messaging traffic and may have limited ability to make use of aggregated audience behavior information that may be useful for improved system performance.

### SUMMARY OF THE INVENTION

The present invention relates to the delivery of targeted assets into a scheduled network programming or content stream, i.e., interspersed with or otherwise combined with other content such as video programming. In particular, the invention relates to implementing targeted asset delivery in contexts where at least some targeted asset functionality, e.g., audience classification, matching of classification parameters to targeting parameters and/or delivery of selected assets, is executed at a platform remote from the UED. In this regard, the invention has particular advantages for implementation in systems where user selections are processed or content streams are dynamically configured at such remote platforms including, for example, switched digital, unicast, multicast and hybrid unicast/multicast distribution systems.

Further, the present invention provides for the targeting of assets for delivery according to specific audience classification parameters (e.g., ethnicity, gender, income level, locale, age, profession, personal interests, or combinations thereof) that may be based on external information (e.g., third party database information, ratings information, subscriber database information, etc.) and/or user input information (e.g., click stream information from a remote control or the like, viewing filters or other setting information, demographic information or explicitly entered by the user, etc.) Two specific types of classifiers of particular interest in this regard are third party database classifiers and click stream classifiers. Third party database classifiers access a database, e.g., of a credit processing agency. Such classifiers can access a large volume of rich demographic information including income information and purchasing behavior among many others. Such information may be used in conjunction with other information including user input information or ratings information. Click stream classifiers use user inputs (e.g., channel selections, volume setting and the like) to estimate classification parameters of a current audience or one or more users. Again, such click stream information may be used in conjunction with ratings information, programming information, third party database information or the like. Accordingly, the noted types of classifiers are not necessarily wholly distinct and each has certain advantages. In any event, such classification functionality may be executed at a remote platform, in certain implementations of the present invention, and take advantage of information available at such platforms in certain network environments.

In accordance with one aspect of the present invention, a method and apparatus (“utility”) for targeted asset delivery is provided where a UED transmits program selections to a remote platform and receives programming and targeted assets based at least in part on the transmitted selections. For example, the programming delivered at the UED and/or the targeted asset may be based on the transmitted selection. The utility involves receiving, at the UED, one or more user inputs reflecting one or more user selections of scheduled programming networks and transmitting to a processing system separate from the UED, message information based on the one or more inputs. For example, in switched digital networks and unicast or multicast television environments, channel selections are generally transmitted to a remote platform in order to execute a channel change. Alternatively, raw click stream inputs or processed inputs may be transmitted in real-time or at selected times in accordance with this aspect of the invention.

The message information is used by the processing system to select one or more assets different than the scheduled programming, e.g., program interspersed, integrated or overlayed advertisements, for transmission to the UED. The UED then receives selected scheduled programming together with the one or more assets selected based at least in part on the message information. For example, the assets may be selected at the UED or the remote platform and may be selected based on the user inputs and/or other information. The assets may be incorporated into a customized content stream directed to the UED or a selected set of UEDs, may be transmitted via bandwidth separate from that of the programming (e.g., via a separate dedicated ad channel for “channel hopping” implementations) and may be transmitted at the time of intended delivery via the UED or ahead of time (forward-and-store).

In one implementation, a channel selection is transmitted from a UED to a remote platform. Based on the channel selection, programming and a targeted asset associated with the programming is transmitted to the UED. The targeted asset may be selected at the remote platform, for example, based on the operation of a third party database or click stream classifier. It will be appreciated that this may be implemented in switched digital, unicast, multicast or hybrid network environments. In these or other environments, targeted asset delivery may alternatively be implemented using a channel hopping or forward-and-store architecture.

Another aspect of the present invention provides a utility for remotely implementing (from the perspective of the UED) processing functionality related to targeted asset delivery. Again, the utility can be used for targeting assets to UEDs in a switched digital, unicast, multicast, or hybrid unicast/multicast content distribution system of scheduled programming networks. The utility involves receiving, at a remote processing system separate from a UED, message information based on one or more user inputs to the UED. This message information may include channel selections or some processed variant of those channel selections such as, for example, a report summarizing the click-stream at a UED, a surfing report summarizing the user channel preferences at the UED, or an asset delivery report summarizing the assets displayed at the UED, all over any specified period of time.

The utility further involves operating the remote processing system to process the message information to select one or more assets, different than scheduled programming of the selected scheduled programming networks, for transmission to the UED. The assets may be selected, for example, by accessing a classification database or by operating a classifier to determine classification parameters currently associated with the UED.

In one implementation, assets are selected for delivery to specific UEDs based on a comparison of the classification parameters to the target parameters associated with all available assets in the content distribution system. Programming together with one or more assets selected based at least in part on the message information may then be transmitted from the remote processing system to the UED. For example, the programming and assets may be transmitted in a single stream or separate streams. In this manner, various targeting functionality is executed remotely from the UED, based on message information transmitted from the UED.

### BRIEF DESCRIPTION OF THE DRAWINGS

For a more complete understanding of the present invention and further advantages thereof, reference is now made to the following detailed description taken in conjunction with the drawings in which:

FIG. 1 illustrates the delivery of different targeted assets to three different users watching the same scheduled network programming content.

FIG. 2 illustrates the functionality of a headend of a network operator configured to receive broadcast content from a number of sources and to process and distribute that content through a content distribution system.

FIG. 3 illustrates the differences between a conventional broadcast content distribution system and a switched digital broadcast content distribution system.

FIG. 4 illustrates one embodiment of a unicast content distribution system configured for targeted asset delivery.

FIG. 5 illustrates the basic items of information to be included in the message information transmitted from each UED to the remote processing system.

FIG. 6 presents an exemplary routing table for assigning each UED to one of several classifiers for classification at the remote processing system.

FIG. 7 illustrates one embodiment of a content distribution system configured to deliver scheduled network programming and targeted assets via different modalities, or via conventional or switched digital broadcast and Internet Protocol Television (“IPTV”), respectively.

FIG. 8 illustrates one embodiment of a multicast content distribution system configured to deliver several instantiations of selected scheduled programming networks interleaved with targeted assets, each to a corresponding grouping of UEDs.

FIG. 9 illustrates another embodiment of a multicast content distribution system configured to serially deliver multicasts of selected scheduled network programming and multicasts targeted assets.

FIG. 10 illustrates another embodiment of a multicast content distribution system configured to deliver targeted assets in an IPTV environment.

FIG. 11 illustrates three exemplary ways in which a schedule programming network could be categorized for delivery of multicasts containing different targeted assets.

FIG. 12 illustrates an embodiment of a targeted asset delivery system configured for a hybrid unicast/multicast distribution system.

FIG. 13 illustrates the use of a digital subscriber line access multiplexer (“DSLAM hub”) in connection a targeted asset delivery system configured for a unicast, multicast, or hybrid unicast/multicast content distribution system.

### DETAILED DESCRIPTION

The present invention relates to methods and systems for the classification of scheduled network programming users (e.g., television viewers, radio listeners, etc.) and the delivery of targeted assets on an individual or highly granular basis. The present invention has particular application with respect to targeted asset delivery within content distribution systems of scheduled programming networks. In this regard, assets may be targeted to UEDs within switched digital, content distribution systems among others. Within the frameworks of these content distribution systems, targeted assets may be delivered via varying system hardware architectures. For the purpose of illustration, several exemplary embodiments will be discussed. One of ordinary skill in the art will appreciate that the present invention is not limited to the embodiments described but, rather, has application to a variety of transmission modes, content distribution systems, and hardware architectures.

The following description is divided into a number of sections. First, it discusses the targeted asset delivery model in general and with respect to the present invention. Second, it describes several exemplary embodiments of the targeted asset delivery methods and systems of the present invention as implemented within various content distribution systems.

### I. The Targeted Asset Delivery Model

The inventive systems and methods and the embodiments described below allow for the delivery of targeted assets that address certain shortcomings and/or inefficiencies associated with proposed targeted asset delivery methods and systems. Generally, targeted asset delivery entails delivering assets to a target audience having desired characteristics. These characteristics, or audience classification parameters, may be defined based on personal information, demographic information, psychographic information, geographic information, or any other information that may be relevant to an asset provider in identifying a target audience. As discussed above, currently asset providers direct their assets based on Nielsen ratings that result from monitoring the observation patterns of a sampling of households to roughly associate audience profiles with certain scheduled content (e.g., television programs) and extrapolate those observation patterns to the audience at large. Asset providers then match the target parameters for a particular asset (i.e., the parameters defining the target audience for the asset) with the audience classification parameters associated with a UED and direct assets accordingly.

For example, under this conventional model, if ratings indicate a particular program has an audience comprised of 60% women, and women comprise the target audience for a particular asset, the asset provider may purchase a commercial spot in that program. But in this case, the asset delivery would result in a 40% error rate, or in other words, 40% of the audience UEDs receiving the asset would be outside the asset provider's target audience.

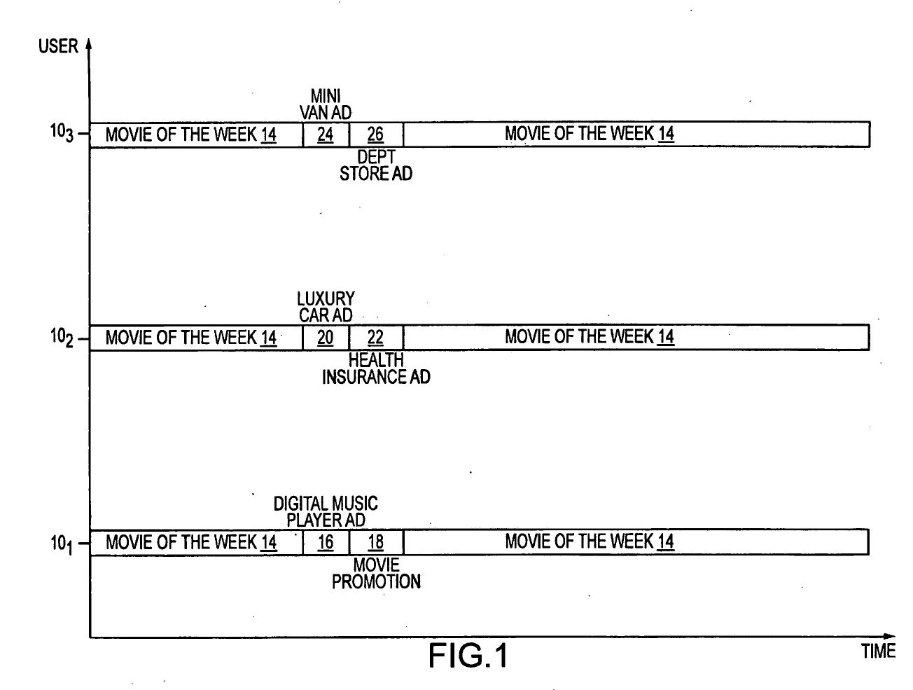

To address this problem, one embodiment of the present invention provides for targeted asset delivery on an individual or at least a fine granular basis. FIG. 1 illustrates the delivery of different targeted assets, in this case advertisements, to three different users 10₁₋₃ watching the same scheduled network programming content 14, in this case denoted “Movie of the Week.” At a given break in the programming, users 10₁₋₃ each receive a different asset package based on the classification parameters associated with UED. Specifically, user 10₁ receives a digital music player ad 16 and a movie promotion 18; user 10₂ receives a luxury car ad 20 and a health insurance ad 22; and user 10₃ receives a minivan ad 24 and a department store ad 26. These assets need not be provided as a package and can be provided on an individual basis. Alternatively, a single asset provider (e.g., a motor vehicle company) may purchase an advertising spot and then provide different asset options for the spot such as, for example, a sports car, a minivan, a pickup truck, etc.

Beyond individualized and/or finely granularized targeted asset delivery, the present invention provides for the ability to continually discern (in approximate real-time) the classification parameters associated with a user(s) currently watching television at the UED. Specifically, in one implementation, the present invention utilizes user inputs, such as real-time channel selections transmitted to a given UED (typically through an RF device such as a remote control) to continually estimate the classification parameters of users at the UED. Alternatively, the household or current audience may be classified independent of monitoring such user inputs, for example, based on accessing a third party data base as discussed above (in such cases, the system may endeavor to distinguish as between multiple household members based on user input information or independent or user inputs, e.g., based on ratings information for the current program). Preferably, but not necessarily, the system can estimate who's watching now. That is, rather than simply targeting assets based on a set of static household classification parameters, which cannot account for the variety of audiences associated with any given UED, the present invention allows for the dynamic estimation of classification parameters according to “who's watching now.” This ability helps providers reach their target audiences with a high degree of precision.

For example, if household A comprises a mother, a father, and two teenage sons, the present invention provides for a continual estimation of classification parameters that will vary depending on which family member or combination of family members is watching television. Based on this variance in classification parameters, different assets may be selected for delivery to the UED when the mother is watching versus when a teenage son is watching. This could include delivering different assets, for example if the mother is watching one UED and teenage son is simultaneously watching a second UED, but they are both watching the same program.

In addition, there may be instances where it is undesirable or impracticable to perform a full range of asset targeting functionality—e.g., to continually classify (e.g., continually estimate user classification parameters), select assets for delivery, and in some instances, deliver assets into the scheduled network programming stream—at the UED itself. In other cases, it may simply be advantageous to execute these functions remotely.

For instance, in channel hopping implementations, a given UED may have a limited array of asset channels from which to choose, thereby limiting the number of potential assets that can be sent to the UED for UED based selection. In addition, implementing certain functionality all the UED may require custom logic and utilize UED resources. This may delay systems deployment or be objectionable to network providers or equipment providers. Moreover, classifying, selecting, and delivering targeted assets from one or more remote platforms or remote processing systems may take advantage of upstream logic and messaging capabilities already at least partly present in many content distribution systems. Moreover, some proposed methods for targeted asset delivery require logic resident at each UED to cast votes through the content delivery system regarding the targeted assets best suited to the users associated with that UED. As a result, the remote classification and selection of assets may eliminate voting traffic that burdens the distribution system. Fulfilling these functions remotely, rather than at each UED, simplifies the system architecture by removing the need to duplicate the requisite logic on every UED, which allows for upgrades and/or modifications to the system architecture without requiring service at, or replacement of, each UED. Also, implementing certain functionality remotely facilitates access to aggregated information (e.g., related to the multiple households) as may be desired.

II. Targeted Asset Delivery within Existing or Proposed Content Distribution Systems

As mentioned above, one or more of the classification, selection, and delivery of targeted assets may be accomplished through a remote processing system or several remote processing systems working together. Each remote processing system may operate within the framework of a network content distribution system. Several content distribution systems have been proposed and/or implemented for delivering scheduled network programming, and each presents its own set of challenges and opportunities for targeted asset delivery. These content distribution systems include conventional broadcast, switched digital broadcast, unicast, multicast, and hybrid unicast/multicast content distribution systems.

a. Conventional Broadcast Content Distribution System

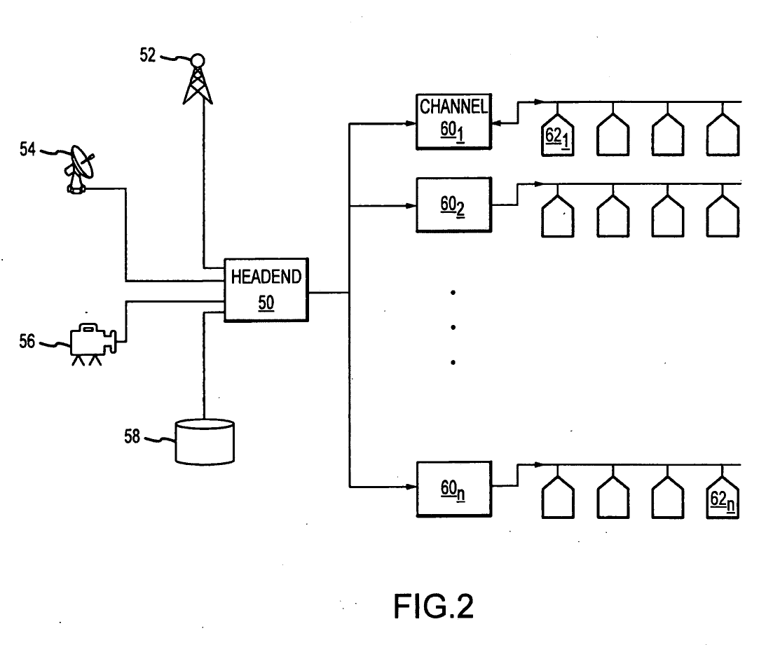

In a conventional broadcast system, all UEDs in any given content distribution subdivision receive the same content stream or multiplex of content streams from the headend of the network operator, commonly referred to as a Multiple Systems Operator (“MSO”) such as, for example, Comcast or Cox Communications. The headend functions as a platform for receiving broadcast content from any number of sources for processing and distribution through a content distribution system. As shown in FIG. 2, the headend 50 may receive content from an antenna 52, for example, for receiving content via the airwaves, a satellite dish 54 for receiving content via satellite communications, a fiber link 56 for receiving content directly from studios, a video storage source 58, or other content sources. One of ordinary skill in the art will appreciate that the illustrated sources 52, 54, 56, 58 are provided for illustration only and other sources may be used. After aggregating the broadcast content, the headend operates to assign each content feed to a specific frequency band or channel 60₁₋ₙ and insert scheduled programming content into that channel for delivery to UEDs 62₁₋ₙ within the network.

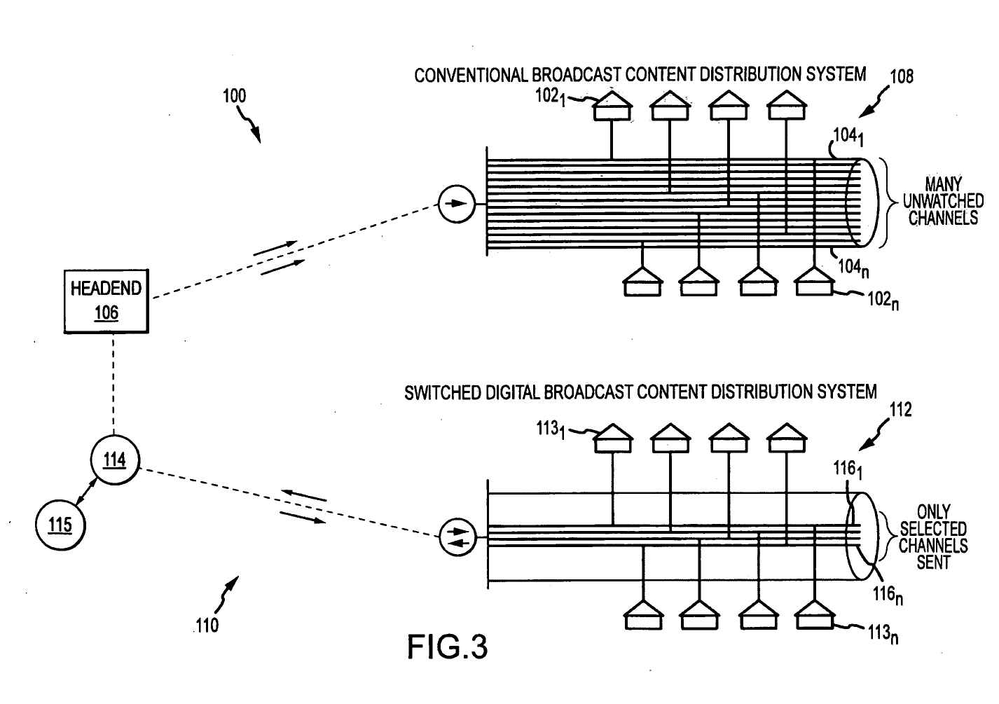

Thus, in a conventional broadcast content distribution system 100 as shown in FIG. 3, all UEDs 102₁₋ₙ in a given subdivision 108 receive an identical set of several hundred scheduled programming networks 104₁₋ₙ as assigned to specific bandwidth segments or channels at the headend 106. While broadcast content distribution systems have substantial bandwidth available for targeted asset delivery, the broadcast nature of these content distribution systems may inhibit targeted advertising because it generally lacks the ability to deliver customized content to different UEDs on a given channel at a given time, though multiple customized instantiations of a channel could be provided in a broadcast network. That said, conventional broadcast systems do allow for targeted advertising functions to be executed at the UED, as described in U.S. patent application Ser. No. 11/743,544, filed May 2, 2007, entitled, “Fuzzy Logic Based Viewer Identification for Targeted Asset Delivery System,” and U.S. patent application Ser. No. 11/743,540, filed May 2, 2007, entitled, “Method and Apparatus to Perform Real-Time Audience Estimation and Commercial Selection Suitable for Targeted Advertising” (the “classifier applications”), both of which are fully incorporated herein by reference. And in certain circumstances, conventional broadcast systems may allow for at least an amount of remote processing functionality related to targeted asset delivery to be executed from a remote platform or processing system, as discussed below in Section II(g).

b. Switched Digital Broadcast Content Distribution System

In a switched digital broadcast content distribution system 110, as shown in FIG. 3, the content distribution system is divided into a number of system subdivisions 112 on a relatively fine geographic basis. UEDs 113₁₋ₙ transmit channel selections to a distribution switch 114, located between the UEDs 113₁₋ₙ and the headend 106, which is responsible for determining the subset of networks to be broadcast in the subdivision. As a result, the UEDs 113₁₋ₙ within subdivision 112 may receive a different subset 116₁₋ₙ of the set of scheduled programming networks made available in the content distribution system from the headend 106 depending on the channels selected by users at UEDs 118₁₋ₙ within the subdivision 112.

In a switched digital broadcast distribution system 110, unwatched channels need not be broadcasted so that additional uses may be made of the freed-up bandwidth. While a switched digital broadcast system involves communication between the UEDs 113₁₋ₙ and a remote distribution switch 114, the broadcast nature of content delivery between the distribution switch and the UEDs has not been utilized is not well suited for targeted asset delivery. Similar to a conventional broadcast system, however, a switched digital broadcast system does allow certain targeted advertising functions to be executed at the UED as described in the classifier applications. Alternatively, to take advantage of the channel selections 116₁₋ₙ already being transmitted to the remote distribution switch 114, a remote processing system 115 may be located at the distribution switch 114 and configured to perform some remote processing functionality such as, for example, the functionality discussed below in Section II(g).

c. Unicast Content Distribution System

By contrast, in a unicast content distribution system, programming is still scheduled, but an individualized content stream is delivered from a remote processing system. Though it requires considerable system-wide bandwidth, a unicast content distribution system allows for customization of a content stream to, for example, include targeted assets on a UED-by-UED basis.

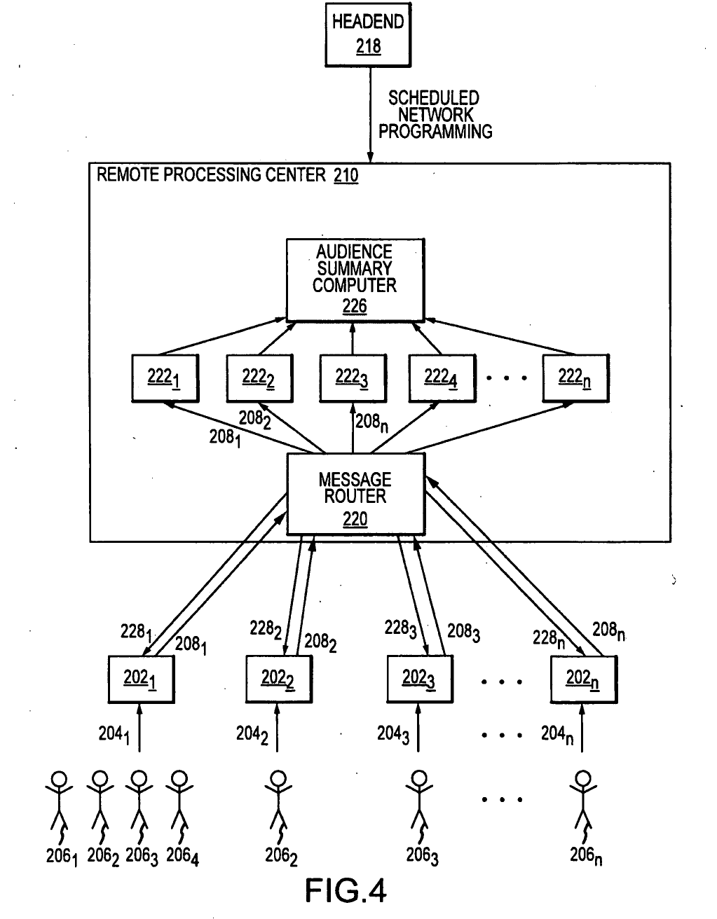

FIG. 4 illustrates an exemplary embodiment of a unicast content distribution system configured for targeted asset delivery. In this embodiment, several UEDs 202₁₋ₙ may receive one or more user inputs, or a “click-stream,” 204₁₋ₙ such as scheduled programming network selection selections by users 206₁₋ₙ viewing at the UEDs 202₁₋ₙ (generally through a remote control or some other RF device). One of ordinary skill in the art will recognize that, in some instances, there may be more than one user at a UED at any given time, as shown in FIG. 4. While only one user will convey a channel selection to the UED, it should be appreciated that this channel selection is presumed to represent the collective group of users at the UED.

The UEDs 202₁₋ₙ receive the user inputs 204₁₋ₙ and transmit sets of message information 208₁₋ₙ, based on the channel selections 204₁₋ₙ to a remote processing system 210. It will be appreciated that unicast systems generally require this information in order to provide a custom unicast content stream. The illustrated system eavesdrops on these messages for classification of the current users at each UED, as well as selection and delivery of targeted assets into the selected scheduled network programming streams. Finally, the unicast content stream 228₁₋ₙ, or a stream of selected scheduled network programming interleaved with targeted assets, is directed to each UED 202₁₋ₙ for display to the user.

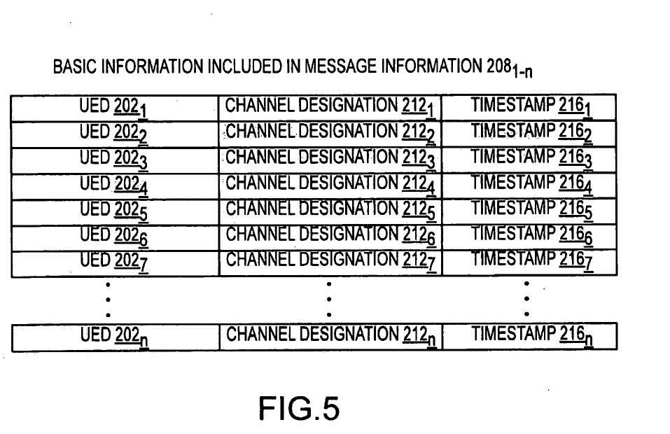

To aid in estimating classification parameters for each UED 202₁₋ₙ, the message information 208₁₋ₙ transmitted upstream from each UED 202₁₋ₙ may include a unique UED identifier 202₁₋ₙ and a channel designation 212₁₋ₙ, as summarized in FIG. 5. In addition, and as shown in FIG. 5, it may be desirable for the message information 208₁₋ₙ, to include a timestamp 216₁₋ₙ indicating the approximate time of the channel change. Timestamps 216₁₋ₙ need not be exact, but they should typically reflect a time that is within one or two seconds of the corresponding channel selection 204₁₋ₙ. If the UED 202₁₋ₙ is not configured to include a timestamp 216₁₋ₙ in the transmitted message information 208₁₋ₙ, then a timestamp may be added by another upstream component before the message information 208₁₋ₙ arrives for processing at the classification computer(s), discussed below.

The message information 208₁₋ₙ may also take many different forms. For instance, the channel designation 212₁₋ₙ may indicate an actual channel or network identifier or it may be a more indirect mechanism such as an Internet Control Message Protocol (“ICMP”) address. The message information need only provide an identifier unique to a stream of scheduled network programming. Likewise, the UED identifier may take many forms. It may be a Media Access Control (“MAC”) address or some other serial number present in the UED, so long as it uniquely identifies the UED within the remote processing system. Alternatively or additionally, dedicated messages may be provided for use in audience classification. In this regard, the message information 208₁₋ₙ transmitted from the UEDs 202₁₋ₙ may include some processed variant of the raw user input(s) 204₁₋ₙ. For example, the message information 208₁₋ₙ could comprise a filter report, a report summarizing the click-stream at the UED over a specified period of time, or a report summarizing the assets played at the UED over a specified period of time.

As discussed above, each UED 202₁₋ₙ transmits the message information 208₁₋ₙ to a remote processing system 210. One of ordinary skill in the art will readily understand that the remote processing system 210 may be located at any one or several intermediate locations within the content distribution system separate and upstream from the UEDs 202₁₋ₙ. For instance, in the embodiment illustrated in FIG. 4, the remote processing system 110 is located at an intermediate platform between a headend 218 and the UEDs 202₁₋ₙ. Alternatively, in another embodiment, the remote processing system 210 may be located at the headend 218.

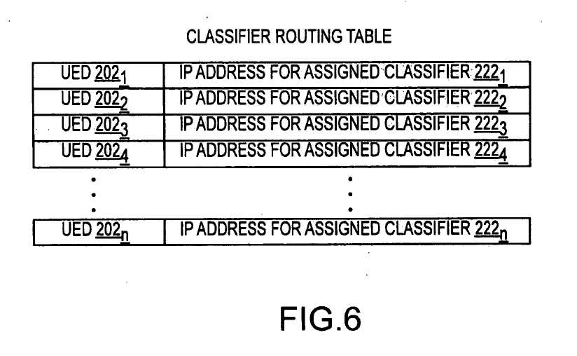

In the embodiment illustrated in FIG. 4, the remote processing system 210 comprises a message router 220 that receives message information 208₁₋ₙ from the UEDs 202₁₋ₙ, reformats the message information 208₁₋ₙ if necessary (e.g., adds a timestamp, reconfigures the message information to a proprietary format, etc.), and routes the message information 208₁₋ₙ to one or more classification computers 222₁₋ₙ, also called the classifier(s), for classification. In this regard, for implementations where the system eavesdrops on messages conventionally used in the network, the message may need to be copied so that the original message can go to its original destination and the copied message can be used for targeted asset delivery. If a single classification computer cannot handle the memory, processing, or network throughput requirements for hundreds or thousands of UEDs, then the remote processing system 210 may comprise several classification computers 222₁₋ₙ, with each classification computer 222₁₋ₙ being assigned to a specific group of UEDs 202₁₋ₙ, according to for example, the classifier's Internet Protocol (“IP”) address, as shown in the routing table of FIG. 6. Using the classification computer(s) 222₁₋ₙ, the remote processing system 210 estimates the classification parameters for each UED and, by comparing the classification parameters to the target parameters associated with each asset available in the distribution system, selects targeted assets for delivery into the scheduled network programming directed to each individual UED 202₁₋ₙ.

There are several methods the classification computer(s) may employ to estimate classification parameters based on message information transmitted from the UEDs. Two exemplary methods are described in the classifier applications. The methods described in the classifier applications may execute on a general purpose computer or computers.

Many of the techniques taught in the classifier applications are described in terms of implementation at each UED. The present invention, however, employs the methods of the classifier applications to classify many UEDs from a remotely located classifier at the remote processing system. The fundamental difference between a UED implementation, as described in the classifier applications, and a remote implementation, as described herein, is the number of UEDs classified by one classifier. For instance, whereas a processor within a UED performs classification calculations for only that UED in real-time, a single classification computer within a remote processing system performs classification calculations for hundreds or thousands of UEDs at approximately the same time. Since a remote classifier must provide classification for several UEDs at once, a remote classifier will only run in approximate real time according to one of three implementation strategies: (1) multiple individual processes, (2) a monolithic process, or (3) a combined approach using several monolithic processes.

In one embodiment of a multiple individual process approach, a separate operating process within the classification computer represents each UED and its classifier state. This approach relies on standard timesharing techniques allowing many processes to run simultaneously on one computer. Processes periodically either wake-up or are awakened by the operating system when needed to perform processing functions. In this embodiment, the individual process implementation will typically utilize a separate control process that receives sets of message information 208₁₋ₙ from the message router 220 and dispatches each set of message information individually to the classifier process responsible for that particular UED. This causes the classifier process for that particular UED to become active and process the message information. In addition, and depending upon the design of the classifier, it may be necessary for each process to periodically perform some additional computations using the methods provided by a general purpose timesharing operating system such as, for example, timed waits.

Alternatively, in a monolithic process implementation, a single operating system process classifies many UEDs. In one embodiment of this type of monolithic process, variables stored in a unique region of memory at the classification computer 222₁₋ₙ represent each UED 202₁₋ₙ and its corresponding classifier state. As message information 208₁₋ₙ arrives from the message router 220, it is sequentially acted upon by the monolithic process, in some cases in an order different than the order in which the sets of message information 208₁₋ₙ were received. In this embodiment, the general execution framework for processing a set of message information 208₁₋ₙ comprises extracting the classifier state for the particular UED 202₁₋ₙ from memory, performing the classification calculations, and then storing the classifier state back into memory. Similar to the multiple individual process approach, it may be necessary to periodically perform some computations on behalf of each UED. If this circumstance arises, the monolithic process can loop through the UED classifier instances that require additional processing.

In another alternative embodiment, several monolithic processes may each classify a set of UEDs. In each of the classifier processing implementations just described (multiple-individual, monolithic, and multiple-several), the maximum number of UEDs that may be classified by a single classifier 222₁₋ₙ is determined by the amount of processing necessary to approximately synchronize processing with real-time.

Even if the number of UEDs 202₁₋ₙ assigned to any classifier is appropriate for the processing capability of the classifier 222₁₋ₙ, the classification processes may not occur in real-time because the classifier computers 222₁₋ₙ are classifying many sets of message information 208₁₋ₙ. First, delay flows from the fact that message information 208₁₋ₙ takes time to propagate from the UEDs 202₁₋ₙ to the remote processing system 210 its and classification computers 222₁₋ₙ. And second, while conventional timesharing allows for the appearance of simultaneous processing, classifier instances actually process sequentially in the remote classification computers 222₁₋ₙ.

The classifiers 222₁₋ₙ may take two general approaches to the time delay: (1) the issue may be ignored, or (2) the classifiers may employ a virtualized time approach. Ignoring delays caused by timesharing in a real-time implementation may be perfectly adequate. The delays caused by message information 208₁₋ₙ moving through the content distribution system are generally less than a few seconds, and the delays caused by the sequential nature of a timesharing processing system add only another few seconds. These delays may not impair the accuracy of the classifiers.

Alternatively, the classifiers may run on virtual time. In one embodiment of the virtual time approach, the classifier state maintained for a UED and its corresponding classifier instance may be assigned a virtual time variable. Periodically, the virtual time variable within the UED classifier instance is updated to reflect a recent, but not current, time as compared to the actual time at the corresponding UED. Sets of message information, marked with the actual time at which each channel selection takes place, are dispatched to the classifier instance corresponding to the originating UED. When the classifier instance's virtual time reaches the actual time of the channel selection, the classifier processes the message information. From its point of view, the classifier instance is operating in real time, but from an outside point of view, the classifier instance is running a small and variable amount of time behind real time.

For example, a channel selection for a first UED may take place at 20:10:13, and the message information corresponding to this channel selection may reach the remote classification computer at 20:10:14.5, after a 1.5 second delay. If the virtual time assigned to classifier instances is maintained at approximately 5 seconds behind the actual time, then the virtual time in the classifier instance upon arrival of the messaging information will be approximately 20:10:9.5. Because the message information would be sent to the classifier instance bearing the actual 20:10:13 timestamp, the classifier instance would hold the message information until its virtual time matches the timestamp before acting on it, or for an additional 3.5 seconds. It may be adequate to increment a classifier's assigned virtual time by several seconds or even a minute at once, as certain embodiments of the classifier techniques described in the classifier applications execute only once a minute, taking into account channel selections during the last minute.

While the classification computers 222₁₋ₙ continually estimate classification parameters for each UED 202₁₋ₙ, the remote processing system 210 may also comprise an audience summary computer 226 to summarize the classification results 224₁₋ₙ for several classification computers 222₁₋ₙ. As shown in FIG. 4, continual classification results 224₁₋ₙ for each UED may be periodically transmitted to the audience summary computer 226. In turn, the audience summary computer 226 tracks the classification results 224₁₋ₙ for each UED 202₁₋ₙ and provides whole audience summaries for the audiences currently viewing a particular scheduled programming network. Various other components (not shown), either within or outside the remote processing center 210 may interface with the audience summary computer 226 to submit queries regarding the audience at a particular UED 202₁₋ₙ or the total audience makeup. For example, if a classification computer is determining the gender of users at each UED, then a query regarding the audience at a specific UED may result in no audience present, male audience present, female audience present, or mixed audience present. A query regarding the total audience for a particular scheduled programming network may respond, for example, that there are 1030 male viewers and 2133 female viewers currently watching on 2976 UEDs.

In one embodiment, the audience summary computer 226 may also be configured to allow sophisticated cross-network queries. For example, asset providers might make queries regarding the network with the largest current audience, the network with the largest current female audience, the number of UEDs tuned away from a given network within the last minute, or the number of users in a specific geographic region.

In yet another embodiment, the audience summary computer 226 may also apply statistical techniques to the audience estimates in order to produce probability distributions or error estimates for the audience estimates, as described in U.S. patent application Ser. No. 11/743,540, filed May 2, 2007, entitled “Method and Apparatus to Perform Real-Time Audience Estimation and Commercial Selection Suitable for Targeted Advertising” (“advanced classifier techniques application”). For example, rather than estimate that “5,521” males are viewing ESPN, audience summary computer 226 may provide the following probability distribution: “There is a 90% probability that 3,202 males are viewing ESPN, an 80% probability that 3,621 males are viewing ESPN,” and so on. Alternatively, audience summary computer 226 may provide an error estimate and confidence interval, such as “5,521 males are viewing ESPN +/−552, and this estimate will be accurate 19 out of 20 times.”

Similar to audience summaries and statistical analysis related to those audience summaries, the audience summary computer 226 may also record and report the number of UEDs that displayed any given targeted asset. Using the information provided by the remote classification computers 222₁₋ₙ, the audience summary computer may track the scheduled programming networks to which each UED 102₁₋ₙ is tuned. By combining this information with information regarding the assets selected for each UED, audience summary computer may determine the number of UEDs that played a particular asset and the number of UEDs that tuned away during the asset.

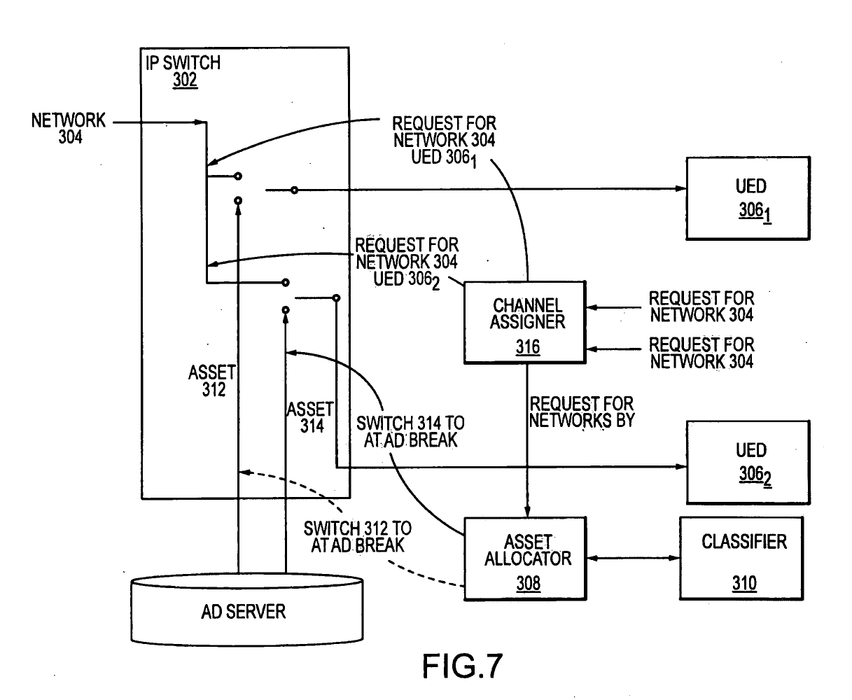

Turning to another embodiment of a unicast targeted asset delivery system, it will be appreciated that scheduled network programming and targeted assets may be delivered via different modalities. For example, in the embodiment shown in FIG. 7, scheduled network programming may be delivered via conventional or switched digital broadcast, while targeted assets may be delivered via an Internet Protocol Television (“IPTV”) asset delivery system. Specifically, a UED equipped with RF and IPTV inputs such as, for example the Motorola QIP2500, would be able to receive both RF scheduled network programming and IPTV targeted asset streams. In this embodiment, the targeted assets may be sent using the IPTV mechanism a few frames ahead of a scheduled break and then buffered and switched as necessary, allowing for individualized targeted assets in a session based unicast.

In greater detail, an IP switch 302 may be operative to copy a scheduled programming network 304, for each UED 306₁₋₂ that requests the network 304 so as to provide multiple instantiations of network 304. An asset allocator 308, with the aid of a classifier 310, receives all channel requests transmitted from the UEDs 306₁₋₂ to the channel assigner 316 and determines classification parameters on a UED-by-UED basis. Comparing the classification parameters for the UEDs 306₁₋₂ to the targeting parameters associated with all available assets, the asset allocator 308 then determines that the first UED 306₁, which is receiving network 304, should receive the first asset 312 and the second UED 306₂, also receiving network 304, should receive the second asset 314. Accordingly, the allocator 308 controls the IP switch 302 to deliver the appropriate assets to the appropriate UED network streams at the scheduled break. This can be implemented in various ways. For example, the UED may be controlled, based on control signals from a headend including timing information to actively switch to the unicast containing the appropriate assets. Alternatively, such control information may be implicit in the stream arriving at the UED, i.e., causing the UED to switch at a predefined time interval after the stream arrives.

d. Multicast Content Distribution System

In some instances, it may not be necessary to construct a unique set of scheduled network programming and targeted assets for each of, perhaps, many thousands of UEDs. In these instances, it may be desirable to utilize a limited set of asset options for a given asset spot and deliver them into the selected scheduled network programming according to groups of similarly classified UEDs. As a result, in a multicast content distribution system, the remote processing system provides an identical content stream or multiplex of streams to each of multiple UEDs.

There are several ways that scheduled network programming and targeted assets may be directed to groupings of UEDs within a multicast distribution system. In one embodiment, and using the classification methods described above with respect to the unicast content distribution system of FIG. 4, users at several UEDs may make selections from the available scheduled network programming. Message information is transmitted from each UED to a remote processing system where the remote processing system assigns UEDs to multicast groups based both on the selected programming and the classification parameters associated with the UED.

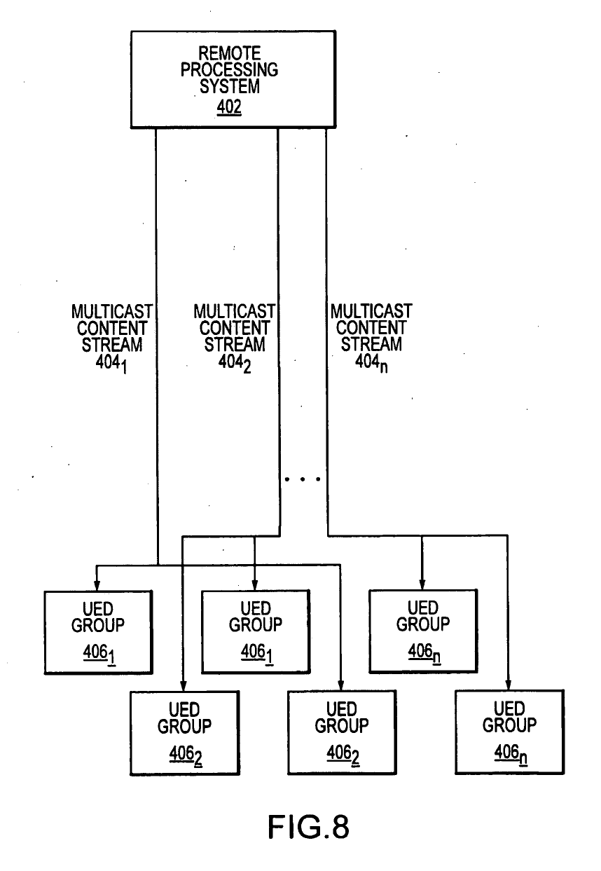

FIG. 8 illustrates one embodiment of a remote processing system 402 that delivers several instantiations of the selected scheduled programming networks interleaved with targeted assets, or multicast content streams, 404₁₋ₙ, each to a corresponding grouping of UEDs 406₁₋ₙ. In this regard, the multicast distribution system handles multiple instantiations of scheduled network programming as thought they are different scheduled programming networks. In some embodiments, it may be practical to limit the number of instantiations to a few for each of a few supported programming networks.

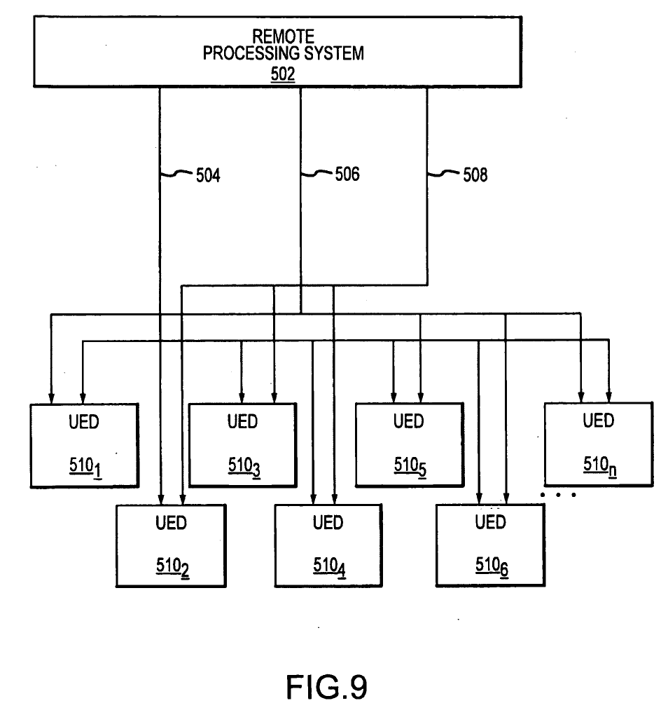

In another embodiment of a multicast content distribution system configured for targeted asset delivery, as shown in FIG. 9, selected scheduled network programming and targeted asset multicasts may be executed serially. For example, a remote processing center 502 multicasts a selected scheduled network programming segment 504 to all UEDs 510₁₋ₙ selecting network 504. Segment 504 is followed by either targeted asset set 506 or targeted asset set 508, depending on the estimated classification parameters associated with each UED 510₁₋ₙ. Alternatively, where bandwidth and system architecture allow for simultaneous receipt of multiple multicast streams or a multiplexed multicast stream at the UED, the programming and asset multicasts may be temporarily overlapped with appropriate logic at the UED to manage system delivery.

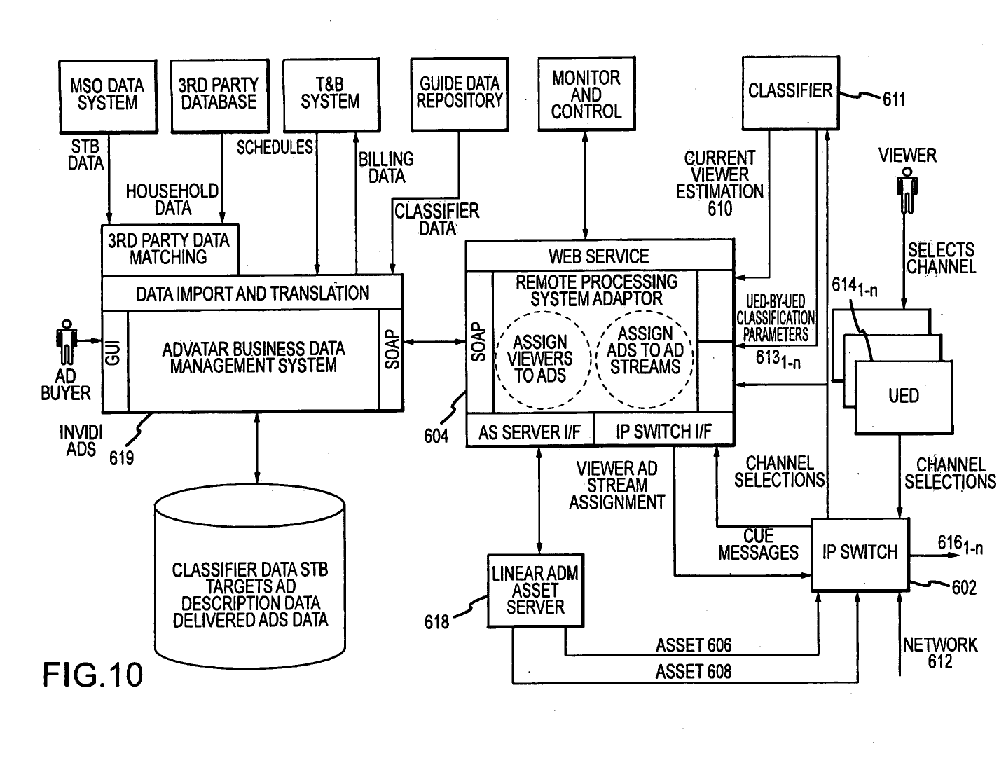

In yet another embodiment of a multicast content distribution system configured for targeted asset delivery in an IPTV environment, as shown in FIG. 10, an IP switch 602 detects an impending break in a scheduled network programming segment 612 and signals a remote processing system adaptor 604 that an advertising break is imminent. In turn, the remote processing system adaptor 604 selects targeted assets 606, 608 with the assistance of a classifier 611 that estimates classification parameters on a UED-by-UED basis and also provides a current estimate of the total viewing audience 610 for the scheduled programming network 612. Using the classification parameters 613₁₋ₙ for each UED 614₁₋ₙ, the remote processing system adapter 604 assigns each UED 614₁₋ₙ to one of a finite set of scheduled programming network copies 616₁₋ₙ that are set to receive different targeted asset packages, a mechanism referred to as many-multicast. The remote processing system adaptor 604 then instructs an asset server 618 to transmit appropriate media streams for the targeted assets 606, 608 to the IP switch 602, while it also instructs the IP switch 602 as to how to switch the targeted asset steams 606, 608 into the scheduled network programming copies 616₁₋ₙ being transmitted. When the break arrives, the asset server 618 transmits the targeted asset media 606, 608, and the IP switch 602 splices them into the programming network copies 616₁₋ₙ such that users may view the targeted assets.

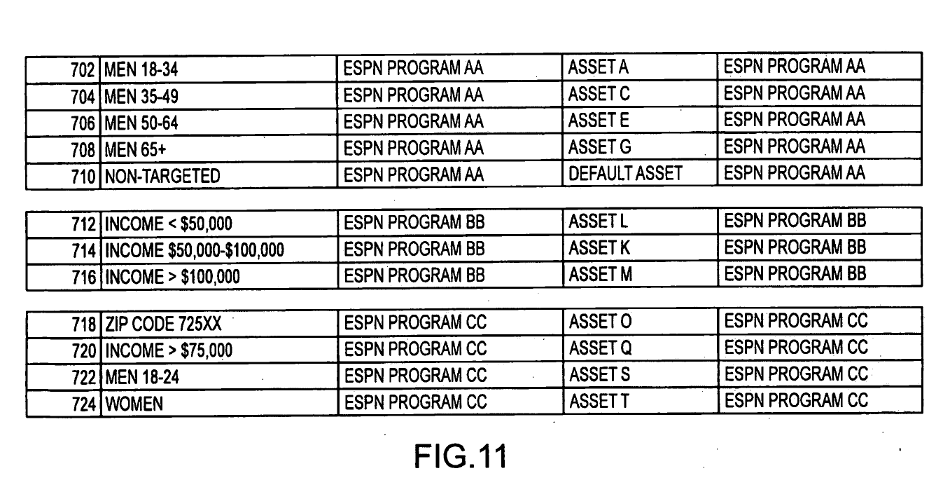

FIG. 11 illustrates three exemplary ways in which a scheduled programming network could be divided into groups. In the first example, ESPN is divided along age/gender lines. Four age categories 702, 704, 706, 708 are defined for male users who receive assets A, C, E, and G, respectively. An additional fifth category 710 comprises users that fall outside one of the defined age categories 702, 704, 706, 708. Users in category 710 receive the default, non-targeted version of ESPN. When a user changes the channel to ESPN, the process discussed above with reference to FIG. 10 is implemented.

The second example illustrated in FIG. 11 is divided along household income lines 712, 714, 716. And the third divides UEDs into a variety of categories, including geographical location 718, income level 720, gender and age combined 722, and gender 724. In the third example, the remote processing system adaptor 604 will assign UEDs to a single channel according to which category is known to maximize either revenue or audience size.

It is possible, in one embodiment, to dynamically change the categories into which UEDs are sorted. For example, looking to FIG. 11, it may be useful to have the age/gender sorting used for Program AA, the income sorting used for Program BB, and the heterogeneous mix of categories used for Program CC, for example, depending on how advertisers want to buy or have bought advertising. One of ordinary skill in the art will appreciate that this sorting may be done along other boundaries. For instance, sorting may be based on time of day or in response to the changing makeup of the network audience.

If users remain on an existing set of multicast channels after the categories have been dynamically shifted, then several different approaches may be taken to prevent any given UED from being placed in an incorrect category, or alternatively, from remaining in an incorrect category for any meaningful length of time. First, the issue may be temporarily ignored, and the user will be reassigned to an appropriate multicast and corresponding channel after an ensuing channel change. Second, the UEDs (or at least a sampling thereof) may transmit asset delivery notifications including a report of what assets were delivered, optionally with information regarding how well the audience “fit” the targeting parameters for the asset. In this regard, the remote processing system may filter any asset delivery notifications transmitted from the UEDs such that it detects when a UED has been incorrectly categorized. Third, the remote processing system may assign new multicast streams to new channels and reassign UEDs to new streams as channel changes occur. Fourth, logic within the remote processing system may trigger the UED to switch from one scheduled network programming stream to another if it is determined that the UED is categorized incorrectly. And finally, an intermediate network switch may be used to remotely, and silently, switch the multicast stream delivered to the UED.

As mentioned above, in this embodiment, the classifier 611 provides the remote processing system adaptor 604 with a continual, real-time estimate of total audience composition 610 for each scheduled network. Using this information, together with knowledge of the inventory of advertising available for placement in the near future, which is made available through the business data management system 619, the remote processing system adapter 604 can, in real-time, simulate the results of various multicast groupings to estimate both the number of successful asset placements and the revenue derived from a particular categorization.

Where adequate network bandwidth and asset delivery capabilities exist, each individual UED 614₁₋ₙ may receive a copy of the scheduled network programming with different targeted assets according to the process discussed above with reference to FIGS. 10 and 11. In other words, if networking capability allows, UEDs 614₁₋ₙ may be classified on such a granularized basis as to direct a unicast of scheduled network programming interleaved with targeted assets to each UED.

e. Hybrid Unicast/Multicast Content Distribution System

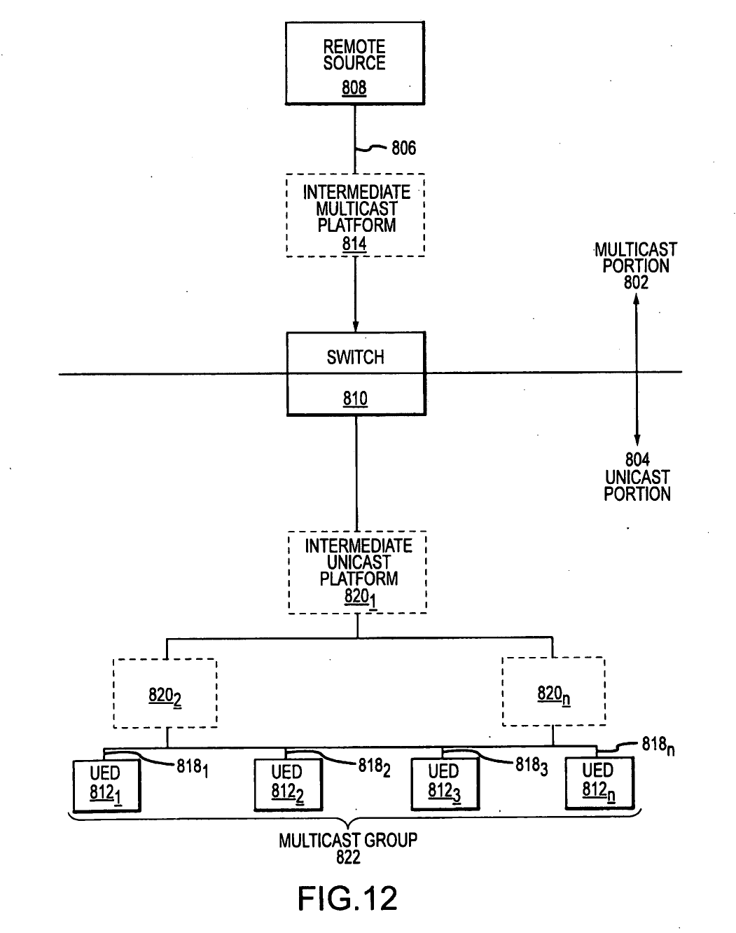

Another embodiment involves a targeted asset delivery system configured for a hybrid unicast/multicast distribution system illustrated in FIG. 12. This embodiment includes a multicast portion 802 and a unicast portion 804. In the multicast portion 802, a scheduled network programming stream 806, destined for each UED 812₁₋ₙ in a multicast group 822, is transmitted from a remote source 808 such as, for example, a remote processing center, to a switch 810. The multicast scheduled network programming stream 806 may be interspersed with default assets to be delivered to any UED 812₁₋ₙ for which targeting is not provided (e.g., nonparticipating UEDs or any UED for which the classification parameters match the targeting parameters of the default asset). In addition, one or more intermediate platforms 814 may be included within the multicast portion 802 of the system.

The switch 810 is operative to convert the multicast portion 802 into multiple unicast instantiations 818₁₋ₙ. For example, each unicast instantiation 818₁₋ₙ may include the multicast programming stream 806, interspersed with targeted assets that can vary on a UED-by-UED basis. As with the multicast portion 802, the unicast portion 804 may comprise one or more intermediate platforms 820₁₋ₙ.

Alternatively, the unicast portion 804 may instead be a sub-multicast distribution system. For example, the multicast group 822 may be divided into a finite number of subgroups, each associated with an identical sub-multicast corresponding to a group of UEDs that matches the targeting parameters of an available asset.

f. Routing Digital Signals within Unicast, Multicast, or Hybrid Content Distribution Systems

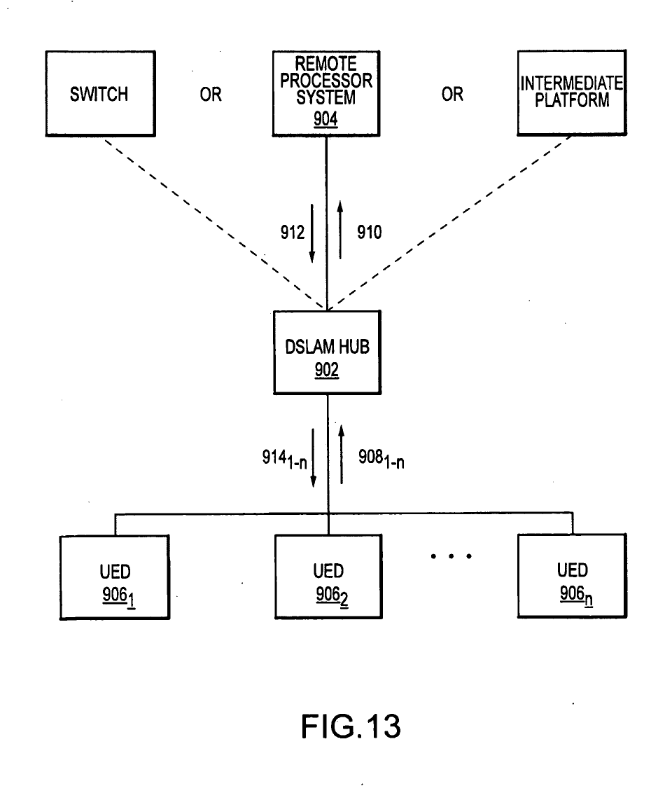

Embodiments of a unicast, multicast, or hybrid content distribution system configured for targeted asset delivery may include a digital subscriber line access multiplexer (“DSLAM hub”) 902 that resides between the remote processing system (or, in different embodiments, any switch or intermediate platform) 904 and the UEDs 906₁₋ₙ, as shown in FIG. 13. The DSLAM hub 902 may be configured to multiplex one or more sets of message information 908₁₋ₙ based on user inputs received at one or more UEDs 906₁₋ₙ and transmit the multiplexed signal 910 to the remote processing system 902 for classification, asset selection, and delivery as discussed with respect to the several embodiments described above. Once a targeted asset package has been selected for each UED (in a unicast system) or for each grouping of UEDs (in a multicast system), the remote processing system may transmit a multiplex of scheduled network programming interleaved with selected targeted assets 912 to the DSLAM hub 902, which demuxes the signal and transmits an appropriate unicast 914₁₋ₙ to each UED 906₁₋ₙ, or in an alternative embodiment, an appropriate multicast to each group of LEDs.

g. Remotely Guided Channel Hopping and Forward and Store Applications

The embodiments discussed above apply to the remote delivery of targeted assets into the selected scheduled network programming such that each UED does not play a role in estimating classification parameters associated with the UEDs, selecting targeted assets to be shown at the UED, or delivering targeted assets into breaks in the scheduled network programming.

In other embodiments, however, several copies of scheduled network programming combined with different targeted asset packages may be transmitted along with instructions to each UED regarding which stream to show at the UED. Specifically, classification computers at the remote processing system may use message information transmitted from UEDs to estimate classification parameters for the current users watching television at the UEDs. The classification results may then be used to generate a number of copies of the selected scheduled network programming streams, each interleaved with different targeted assets. The various network copies may be broadcast via a conventional or switched digital broadcast system, and using an appropriately configured DSLAM, each UED may be instructed as to which stream to play at the UED. The UED may then switch (invisibly from the user's perspective), as described in U.S. patent application Ser. No. 11/331,835, to the appropriate stream of selected scheduled network programming and targeted asset package selected for that UED. Alternatively, the UED may select which stream to play based on operation of local classifiers. As a further alternative, a remote classifier as discussed above may be used to select assets for forwarding to UEDs ahead of play time for forward-and-store system implementations.

In yet another embodiment, classification computers at the remote processing system may use message information transmitted from several UEDs to estimate classification parameters for the current users watching television at the UEDs. The classification results may then be used to select assets for each UED or group of UEDs, and the targeted assets may be forwarded to the UEDs with instructions for later delivery into the broadcasted scheduled network programming. Each UED may then store its respective targeted assets for delivery at the scheduled network programming break, as described in U.S. patent application Ser. No. 11/331,835.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A method for use in targeting assets to user equipment devices in a content distribution system of scheduled programming networks, comprising the steps of:
receiving, at a user equipment device, one or more user inputs reflecting one or more user selections of scheduled programming networks;
transmitting, from said user equipment device to a processing system separate from said user equipment device, message information based on said one or more user inputs, wherein said processing system is operative to process said message information to select one or more assets, different than scheduled programming of said selected scheduled programming networks, for transmission to said user equipment device; and
receiving, at said user equipment device, selected scheduled programming together with said one or more assets selected based at least in part on said message information.

2. The method of claim 1, wherein said processing system is operative to process said message information to continually determine one or more classification parameters of a current user based at least in part on said message information.

3. The method of claim 1, wherein said step of transmitting said message information based on said one or more user inputs comprises transmitting said one or more user inputs.

4. The method of claim 1, wherein said step of transmitting said message information based on said one or more user inputs comprises transmitting a processed variant of said one or more user inputs.

5. The method of claim 4, wherein said step of transmitting said processed variant of said one or more user inputs comprises transmitting at least one of a click-stream report, a surfing filter report, or an asset delivery report.

6. The method of claim 5, wherein said step of transmitting said click-stream report comprises transmitting a summary of programming selected at said user equipment device over a specified time period.

7. The method of claim 5, wherein said step of transmitting said surfing filter report comprises transmitting a summary of programming preferences associated with said user equipment device.

8. The method of claim 5, wherein said step of transmitting said asset delivery report comprises transmitting a summary of assets played at said user equipment device over a specified time period.

9. The method of claim 1, wherein said steps of receiving said one or more user inputs, transmitting said message information based on said one or more user inputs, and receiving said selected scheduled programming with said one or more assets occur in a unicast content distribution system.

10. The method of claim 1, wherein said steps of receiving said one or more user inputs, transmitting said message information based on said one or more user inputs, and receiving said selected scheduled programming with said one or more assets occur in a multicast content distribution system.

11. The method of claim 1, wherein said steps of receiving said one or more user inputs, transmitting said message information based on said one or more user inputs, and receiving said selected scheduled programming with said one or more assets occur in a hybrid content distribution system.

12. The method of claim 11, wherein said hybrid content distribution system comprises a unicast distribution portion and a multicast distribution portion.

13. A method for use in targeting assets to user equipment devices in a content distribution system of scheduled programming networks comprising the steps of:
receiving, at a processing system separate from a user equipment device, message information based on one or more user inputs to said user equipment device;
operating said processing system to process said message information to select one or more assets, different than scheduled programming of said select scheduled programming networks, for transmission to said user equipment device; and
transmitting, from said processing system to said user equipment device, selected scheduled programming together with said one or more assets selected based at least in part on said message information.

14. The method of claim 13, wherein said step of receiving said message information based on said one or more user inputs comprises receiving said one or more user inputs.

15. The method of claim 13, wherein said step of receiving said message information based on said one or more user inputs comprises receiving a processed variant of said one or more user inputs.

16. The method of claim 15, wherein said step of receiving said processed variant of said one or more user inputs comprises receiving at least one of a click-stream report, a surfing filter report, or an asset delivery report.

17. The method of claim 16, wherein said step of receiving said click-stream report comprises receiving a summary of programming selected at said user equipment device over a specified time period.

18. The method of claim 16, wherein said step of receiving said surfing filter report comprises receiving a summary of programming preferences associated with said user equipment device.

19. The method of claim 16, wherein said step of receiving said asset delivery report comprises receiving a summary of assets played at said user equipment device over a specified time period.

20. The method of claim 13, wherein said step of operating said processing system to process said message information to select one or more assets comprises the step of continually determining one or more classification parameters of one or more current users at said user equipment device, wherein said classification parameters are based at least in part on said message information.

21. The method of claim 20, wherein said step of determining said one or more classification parameters comprises determining said one or more classification parameters based on at least one of a group of demographic characteristics consisting of: age, ethnicity, gender, income level, locale, personal interests, and profession.

22. The method of claim 20, wherein said step of operating said processing system to process said message information further comprises the step of comparing one or more asset target parameters with said one or more classification parameters to select one or more assets, different than scheduled programming of said select scheduled programming networks, for transmission to said user equipment device.

23. The method of claim 13, wherein said steps of receiving said message information based on one or more user inputs, operating said processing system to process said message information, and transmitting said selected scheduled programming together with said one or more assets occur in a unicast content distribution system.

24. The method of claim 13, wherein said steps of receiving said message information based on one or more user inputs, operating said processing system to process said message information, and transmitting said selected scheduled programming together with said one or more assets occur in a multicast content distribution system.

25. The method of claim 13, wherein said steps of receiving said message information based on one or more user inputs, operating said processing system to process said message information, and transmitting said selected scheduled programming together with said one or more assets occur in a hybrid content distribution system.

26. The method of claim 25, wherein said hybrid content distribution system comprises a unicast distribution portion and a multicast distribution portion.

27. A system for use in targeting assets to a user equipment device in a content distribution system, comprising:
a remote processing system that receives from a user equipment device message information based on one or more user inputs reflecting one or more user selections of scheduled programming networks, wherein said processing system processes said message information to select one or more assets, different than scheduled programming of said selected scheduled programming networks, and transmits said one or more assets to said user equipment device together with selected scheduled programming.

28. The system of claim 27, wherein said message information based on said one or more user inputs comprises said one or more user inputs.

29. The system of claim 27, wherein said message information based on said one or more user inputs comprises a processed variant of said one or more user inputs.

30. The system of claim 29, wherein said processed variant of said one or more user inputs comprises at least one of a click-stream report, a surfing filter report, or an asset delivery report.

31. The system of claim 30, wherein said click-stream report comprises a summary of programming selected at said user equipment device over a specified time period.

32. The system of claim 30, wherein said surfing filter report comprises a summary of programming preferences associated with said user equipment device.

33. The system of claim 30, wherein said asset delivery report comprises a summary of assets played at said user equipment device over a specified time period.

34. The system of claim 27, wherein said remote processing system comprises:
a classifier for receiving said message information based on said one or more user inputs, wherein said classifier continually determines one or more classification parameters of one or more current users at said user equipment device.

35. The system of claim 34, wherein said one or more classification parameters are based on at least one of a group of demographic characteristics consisting of: age, ethnicity, gender, income level, locale, personal interests, and profession.

36. The system of claim 34, wherein said remote processing system compares one or more asset target parameters with said one or more classification parameters to select one or more assets, different than scheduled programming of said select scheduled programming networks, for transmission to said user equipment device.

37. The system of claim 27, wherein said content distribution system is a unicast content distribution system.

38. The system of claim 27, wherein said content distribution system is a multicast content distribution system.

39. The system of claim 27, wherein said content distribution system is a hybrid content distribution system.

40. The system of claim 39, wherein said hybrid content distribution system comprises a unicast distribution portion and a multicast distribution portion.

41. A system for use in targeting assets from a remote processing system in a content distribution system, comprising:
a user equipment device separate from a remote processing system that receives one or more user inputs reflecting one or more user selections of scheduled programming networks, wherein said user equipment device transmits, from said user equipment device to said remote processing system, message information based on said one or more user inputs, and wherein said user equipment device receives from said remote processing system one or more assets, based at least in part on said message information and different than scheduled programming of said selected scheduled programming networks, together with selected scheduled programming.

42. The system of claim 41, wherein said message information based on said one or more user inputs comprises said one or more user inputs.

43. The system of claim 41, wherein said message information based on said one or more user inputs comprises a processed variant of said one or more user inputs.

44. The system of claim 43, wherein said processed variant of said one or more user inputs comprises at least one of a click-stream report, a surfing filter report, or an asset delivery report.

45. The system of claim 44, wherein said click-stream report comprises a summary of programming selected at said user equipment device over a specified time period.

46. The system of claim 44, wherein said surfing filter report comprises a summary of programming preferences associated with said user equipment device.

47. The system of 44, wherein said asset delivery report comprises a summary of assets played at said user equipment device over a specified time period.

48. The system of claim 41, wherein said content distribution system is a unicast content distribution system.

49. The system of claim 41, wherein said content distribution system is a multicast content distribution system.

50. The system of claim 41, wherein said content distribution system is a hybrid content distribution system.

51. The system of claim 50, wherein said hybrid content distribution system comprises a unicast distribution portion and a multicast distribution portion.

52. The system of claim 41, wherein said one or more assets are based at least in part on one or more classification parameters of one or more current users at said user equipment device, wherein said one or more classification parameters are based at least in part on said message information.
